(19) United States
(12) Patent Application Publication
(10) Pub. No.: US 2025/0242512 A1
(43) Pub. Date: Jul. 31, 2025

(54) LABOR-SAVING VEGETABLE CUTTER AND LABOR-SAVING VEGETABLE CHOPPER

(71) Applicant: JAZZWAY LTD, ZHUHAI CITY (CN)

(72) Inventor: XUEWEN LI, ZHUHAI CITY (CN)

(21) Appl. No.: 18/780,519

(22) Filed: Jul. 23, 2024

(30) Foreign Application Priority Data
Jan. 27, 2024 (CN) 202420218033.2

(51) Int. Cl. B26D 3/26; B26D 3/18; B26D 7/00

(52) U.S. Cl. CPC B26D 3/26; B26D 3/185; B26D 2007/0018; B26D 2210/02

(57) ABSTRACT

A labor-saving vegetable cutter and a labor-saving vegetable chopper are related to the technical field of kitchen utensils. The labor-saving vegetable cutter includes a pressing block and a cutting knife assembly. The cutting knife assembly includes a plurality of cutting knife members stacked together. The cutting knife member includes blade groups, and the blade groups on the plurality of cutting knife member are arranged in an offset manner. When the pressing block presses fruits and vegetables to be cut towards the cutting knife assembly, the fruits and vegetables are sequentially cut by the blade groups on the plurality of cutting knife members. The blade groups of the plurality of cutting knife members are interlaced with each other to cut the fruits and vegetables into strip shapes with a parallelogram cross-section.

### FIELD OF THE DISCLOSURE

The present disclosure relates to kitchenware technology, in particular to a labor-saving vegetable cutter and a labor-saving vegetable chopper.

### BACKGROUND OF THE DISCLOSURE

In modern home life, people typically cut vegetables into blocks, slices, strips, or dices before cooking. Some people also like to cut fruits into dices to make fruit salads or potatoes into strips to make French fries. When using conventional knives to cut fruits and vegetables, not only is the cutting effect suboptimal, resulting in inconsistent sizes and shapes, but the cutting efficiency is also low, with certain safety hazards.

Currently, there are some convenient vegetable choppers on the market, generally used by pressing the fruits and vegetables through the cutter to cut them into uniform strips or blocks. However, in the actual use of these vegetable choppers, users need to exert a lot of force to press the fruits and vegetables through the cutter, making it difficult to use and providing a poor user experience.

### SUMMARY OF THE DISCLOSURE

The purpose of the present disclosure is to address the defects and deficiencies of the prior art and to provide a labor-saving vegetable cutter and a labor-saving vegetable chopper, which have the advantages of high cutting efficiency, labor-saving, and good safety.

To achieve the above purpose, the technical solution provided by a first aspect of the present disclosure is to provide a labor-saving vegetable cutter, including a pressing block and a cutting knife assembly. The cutting knife assembly includes a plurality of cutting knife members stacked together. Each cutting knife member includes a blade group, and the blade groups on the plurality of cutting knife members are arranged in an offset manner such that when the pressing block presses vegetables or fruits to be cut towards the cutting knife assembly, the vegetables or the fruits are sequentially cut by the blade groups on the plurality of cutting knife members. The blade groups of the plurality of cutting knife members are interlaced to cut the vegetables or the fruits into strips with a parallelogram cross-section.

The technical solution provided by a second aspect of the present disclosure is to provide a labor-saving vegetable chopper, including an outer barrel, an inner barrel, and the labor-saving vegetable cutter described above. An outer circumference of the inner barrel fits with an inner circumference of the outer barrel so that the inner barrel is inserted into the outer barrel. The cutting knife assembly is arranged at a lower end of the inner barrel and passes through a bottom of the inner barrel, and the pressing block is arranged at a bottom of the outer barrel.

By means of the technical solution provided by the present disclosure, the beneficial effects are as follows.

1. In the present disclosure, the cutting knife assembly is a component used for cutting fruits and vegetables. The cutting knife assembly includes the plurality of cutting knife members, which are stacked together to form a multi-layer structure of the cutting knife assembly. Each cutting knife member is provided with the blade group, and the blade groups on the plurality of cutting knife members are arranged in the offset manner. When the cutting knife members are stacked, the blade groups on the cutting knife members are not overlapped, so that the blade groups on each layer of the cutting knife members within the cutting knife assembly can perform the cutting function to ensure the cutting effect on the fruits and vegetables. Due to the multi-layer structure of the cutting knife members in the cutting knife assembly and the offset arrangement of the blade groups on the multi-layer cutting knife members, the blade groups of the multi-layer cutting knife members sequentially cut the fruits and vegetables during the cutting process. A number of the blade groups cutting the fruits and vegetables in a single cut is relatively small, a force-bearing area of a single-layer cutting knife member cutting the fruits and vegetables is relatively small, resulting in that a pressure on the fruits and vegetables is relatively large, and a friction is relatively small, so as to make the vegetable cutting process more labor-saving and effortless, thereby enhancing the user experience of the vegetable cutter.

2. In the present disclosure, the pressing block is a component used to press the fruits and vegetables to be cut towards the cutting knife assembly. By using the pressing block to press down on the fruits and vegetables, a user's hand can be prevented from coming into contact with the cutting knife assembly and causing injury, thereby improving safety of the vegetable cutter. The pressing block is provided with blade slots that cooperate with the blade group on the cutting knife assembly. When the pressing block is used to press down on the fruits and vegetables to be cut, the blade group can sink into the blade slot so as to allow the blade group to completely cut through the fruits and vegetables on the pressing block, thereby achieving a good cutting effect. The pressing block can also push out the fruits and vegetables from between the blade groups, ensuring that the fruits and vegetables are not retained or clogged on the cutting knife assembly, enhancing the user experience of the vegetable cutter and making the cutting knife assembly easy to clean.

### BRIEF DESCRIPTION OF THE DRAWINGS

To clearly illustrate the technical solutions of the present disclosure or prior art, the following describes the drawings required for the embodiments or prior art. It is evident that the drawings described below are merely some embodiments of the present disclosure. For those skilled in the art, other drawings can be obtained without creative efforts based on the provided drawings.

FIG. 1 is a schematic structural diagram of present disclosure;

FIG. 2 is a schematic structural diagram of a pressing block of the present disclosure;

FIG. 3 is a schematic exploded view of a cutting knife assembly of the present disclosure;

FIG. 4 is a schematic diagram of the structure of the cutting knife member of the present disclosure;

FIG. 5 is a schematic structural diagram of a labor-saving vegetable chopper of the present disclosure; and

FIG. 6 is a schematic exploded view of the labor-saving vegetable chopper of the present disclosure.

Reference numeral: 1, cutting knife assembly; 2, pressing block; 3, cutting knife member; 4, blade group; 5, blade slot; 6, cutting knife frame; 7, insertion column; 8, insertion slot; 9, outer barrel; 10, inner barrel.

### DETAILED DESCRIPTION OF THE EXEMPLARY EMBODIMENTS

The following provides a detailed description of the present disclosure in conjunction with the accompanying drawings.

These specific implementations are merely explanations of the present disclosure and are not limitations. Those skilled in the art can make modifications to these implementations without creative efforts after reading this specification. As long as they fall within the scope of the claims of the present disclosure, they are protected by patent law.

### Embodiment 1

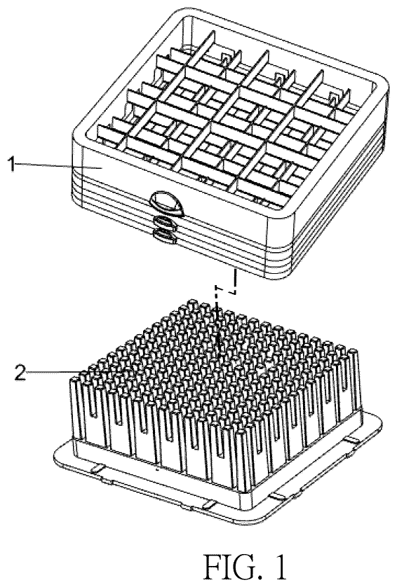

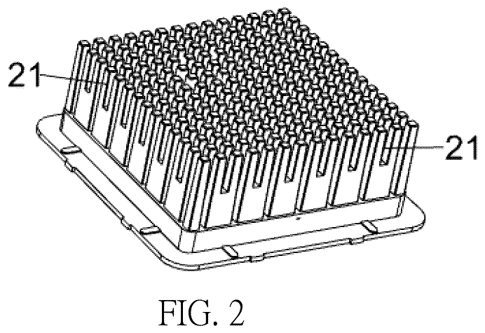

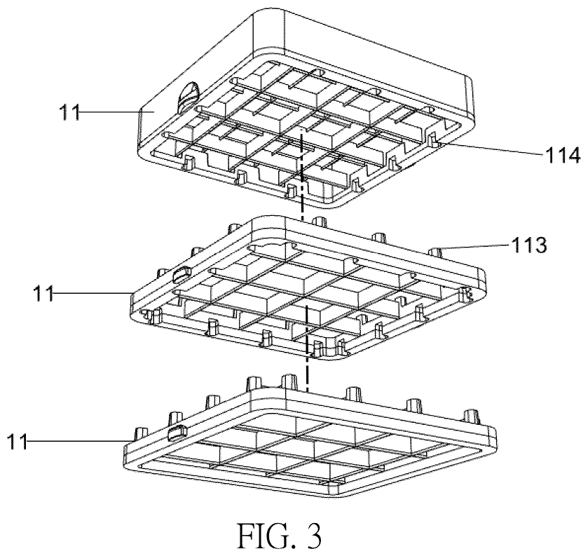

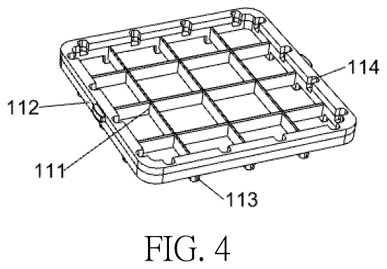

As shown in FIG. 1 to FIG. 4, the present embodiment relates to a labor-saving vegetable cutter, which includes a pressing block 2 and a cutting knife assembly 1.

The cutting knife assembly 1 is used to cut fruits and vegetables, and includes a plurality of cutting knife members 11 stacked together to form a multi-layer structure. Each of the plurality of cutting knife members 11 has a blade group 111. The blade groups 111 on the plurality of cutting knife members 11 are arranged in an offset manner, ensuring that when stacked, the blade groups 111 on the plurality of cutting knife members 11 do not overlap so as to allow the blade group 111 on each layer of the cutting knife members 11 of the cutting knife assembly 1 to cut the fruits and vegetables into strips with a parallelogram cross-section, thereby ensuring effective cutting.

Due to the structure of the cutting knife assembly 1 with the plurality of cutting knife members 11 that are multi-layered, and the offset arrangement of the blade groups 111 on the plurality of cutting knife members 11 that are multi-layered, during a cutting process of fruits and vegetables, the blade groups 111 of the plurality of cutting knife members 11 that are multi-layered will sequentially cut the fruits and vegetables. A number of the blade groups 111 cutting the fruits and vegetables in a single pass is relatively small, and a force area of single-layered cutting knife member 11 is small. As a result, a pressure exerted on the fruits and vegetables is large and a friction is small, such that the cutting process becomes more labor-saving and easier, thereby enhancing the user experience of the vegetable cutter.

The pressing block 2 is used to press the vegetables or the fruits to be cut towards the cutting knife assembly 1. By using the pressing block 2 to press down on the vegetables or the fruits, a user's hand can be prevented from contacting the cutting knife assembly 1 and causing injury, thereby enhancing a safety of using the vegetable cutter. In the present embodiment, the pressing block 2 is provided with blade slots 21 that cooperate with the blade group 111 on the cutting knife assembly 1. When the pressing block 2 is used to press down on the vegetables or the fruits, the blade group 111 can sink into the blade slot 21, thereby allowing the blade group 111 to completely cut through the vegetables or the fruits on the pressing block 2 to achieve a good cutting effect. The pressing block 2 can also push out the vegetables or the fruits from between the blade group 111 to ensure that the vegetables or the fruits are not retained or clogged on the cutting knife assembly 1, thereby improving the user experience and making it easier to clean the cutting knife assembly 1.

In the present embodiment, the plurality of cutting knife members 11 are connected to each other in a detachable manner, so that the plurality of cutting knife members 11 can be disassembled for cleaning and replacement to ensure the performance and hygiene of the cutting knife assembly 1. Additionally, the user can selectively combine several cutting knife members 11 to form a new cutting knife assembly 1, thereby adjusting the cutting effect of the cutting knife assembly 1 to produce vegetable or fruit strips or slices of different thicknesses and widths so as to enhance flexibility and user experience of the cutting knife. Certainly, in other embodiments, the plurality of cutting knife members 11 of the cutting knife assembly 1 can also be fixedly connected to each other.

In the present embodiment, the cutting knife member 11 includes a cutting knife frame 112 and the blade group 111, and the blade group 111 is installed on an inner side of the cutting knife frame 112 to facilitate cutting the fruits and vegetables. One cutting knife frame 112 is provided with insertion columns 113, and another cutting knife frame 112 is provided with insertion slots 114 that match the insertion column 113. The connection between two adjacent cutting knife members 11 is achieved through the cooperation of the insertion columns 113 and the insertion slots 114 to allow for the detachable connection and free combination of the plurality of cutting knife members 11, thereby adjusting the cutting knife assembly 1. Certainly, in other embodiments, other structures can be used to achieve the detachable connection and free combination of the cutting knife members 11.

In the present embodiment, the blade group 111 includes a plurality of blades, and the plurality of blades on the blade group 111 form a crisscross mesh structure to cut the vegetables or the fruits. The interlaced blades provide good overall stability to the blade group to enhance the cutting effect and stability of the vegetable cutter. Certainly, in other embodiments, the blades of the blade group 111 can also be arranged in other patterns, such as a longitudinal parallel mesh structure, a transverse parallel mesh structure, an inclined parallel mesh structure, and an inclined crisscross mesh structure to cut the vegetables or the fruits. The arrangement of the blade groups 111 in the plurality of cutting knife members 11 can vary. For example, the cutting knife member 11 with blade groups arranged in the transverse parallel mesh structure can be used in conjunction with the cutting knife member 11 with blade groups arranged in the longitudinal parallel mesh structure, and the cutting knife assembly 1 can still cut the vegetables or the fruits into strips with a parallelogram cross-section to achieve a good cutting effect.

### Embodiment 2

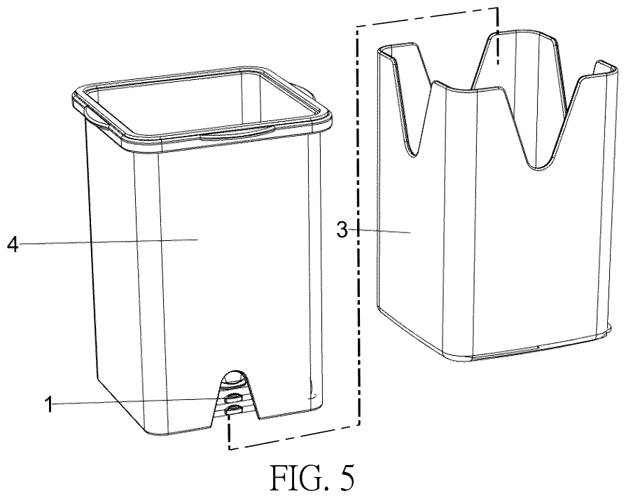

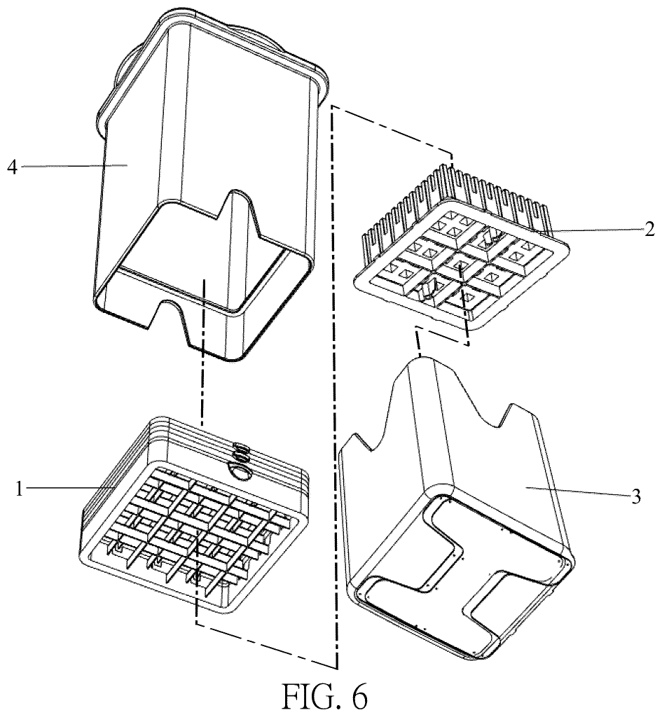

As shown in FIG. 5 and FIG. 6, the present embodiment relates to a labor-saving vegetable chopper, which includes an outer barrel 3, an inner barrel 4, and the labor-saving vegetable cutter as described in Embodiment 1.

A shape of an outer side of the inner barrel 4 is the same as a shape of an inner side of the outer barrel 3, and an outer diameter of the inner barrel 4 matches an inner diameter of the outer barrel 3, allowing the inner barrel 4 to be inserted into the outer barrel 3, with the inner barrel 4 being able to slide stably relative to the outer barrel 3. The pressing block 2 is arranged at a bottom inside the outer barrel 3, and the cutting knife assembly 1 is arranged at a lower end of the inner barrel 4. The cutting knife assembly 1 spans a cross-section of an inner hole at the bottom of the inner barrel 4 and passes through the bottom of the inner barrel 4 from the inside to the outside. The fruits and vegetables can be placed inside the outer barrel 3, where they will be supported by the pressing block 2 at the bottom. When the inner barrel 4 is inserted into the outer barrel 3, pressing down on the inner barrel 4 can allow the fruits and vegetables to contact and be cut by the cutting knife assembly 1. The cut fruits and vegetables will pass through the cutting knife assembly 1 into the inner barrel 4 and can then be removed for use. The cutting process requires only a single downward press of the inner barrel 4 to complete the cutting, making it highly efficient and able to quickly complete the cutting task. Moreover, during the cutting process, the user does not need to touch the cutting knife assembly 1, which can effectively prevent injury from the cutting knife assembly 1 and ensure safety during the cutting process. The multi-layer structure of the cutting knife members 11 in the cutting knife assembly 1 also makes the vegetable cutting process more labor-saving.

The above is merely intended to illustrate the technical solutions of the present disclosure and not to limit them. Other modifications or equivalent replacements made by those skilled in the art to the technical solutions of the present disclosure should fall within the scope of the claims of the present disclosure, as long as they do not depart from the spirit and scope of the technical solutions.

What is claimed is:

1. A labor-saving vegetable cutter, comprising: a pressing block (2) and a cutting knife assembly (1);
wherein the cutting knife assembly (1) includes a plurality of cutting knife members (11) stacked together, each cutting knife member (11) includes a blade group (111), the blade groups (111) on the plurality of cutting knife members (11) are arranged in an offset manner such that when the pressing block (2) presses vegetables or fruits to be cut towards the cutting knife assembly (1), the vegetables or the fruits are sequentially cut by the blade groups (111) on the plurality of cutting knife members (11), and the blade groups (111) of the plurality of cutting knife members (11) are interlaced to cut the vegetables or the fruits into strips with a parallelogram cross-section.

2. The labor-saving vegetable cutter according to claim 1, wherein each blade group (111) includes a plurality of blades, and the plurality of blades form at least one of a crisscross mesh structure, a longitudinal parallel mesh structure, a transverse parallel mesh structure, an inclined parallel mesh structure, and an inclined crisscross mesh structure.

3. The labor-saving vegetable cutter according to claim 1, wherein the pressing block (2) is provided with blade slots (21) that cooperate with the blade group (111).

4. The labor-saving vegetable cutter according to claim 1, wherein the plurality of cutting knife members (11) are fixedly connected to each other.

5. The labor-saving vegetable cutter according to claim 1, wherein the plurality of cutting knife members (11) are detachably connected to each other.

6. The labor-saving vegetable cutter according to claim 1, wherein the cutting knife member (11) includes: a cutting knife frame (112) and the blade group (111), and the blade group (111) is installed on the cutting knife frame (112).

7. The labor-saving vegetable cutter according to claim 6, wherein one cutting knife frame (112) is provided with insertion columns (113), and another cutting knife frame (112) is provided with insertion slots (114) that cooperate with the insertion columns (113), such that the plurality of cutting knife members (11) are detachably connected to each other.

8. A labor-saving vegetable chopper, comprising: an outer barrel (3), an inner barrel (4), and the labor-saving vegetable cutter as claimed in claim 1, wherein an outer circumference of the inner barrel (4) fits with an inner circumference of the outer barrel (3) so that the inner barrel (4) is inserted into the outer barrel (3); wherein the cutting knife assembly (1) is arranged at a lower end of the inner barrel (4) and passes through a bottom of the inner barrel (4); wherein the pressing block (2) is arranged at a bottom of the outer barrel (3).

9. A labor-saving vegetable chopper, comprising: an outer barrel (3), an inner barrel (4), and the labor-saving vegetable cutter as claimed in claim 2, wherein an outer circumference of the inner barrel (4) fits with an inner circumference of the outer barrel (3) so that the inner barrel (4) is inserted into the outer barrel (3); wherein the cutting knife assembly (1) is arranged at a lower end of the inner barrel (4) and passes through a bottom of the inner barrel (4); wherein the pressing block (2) is arranged at a bottom of the outer barrel (3).

10. A labor-saving vegetable chopper, comprising: an outer barrel (3), an inner barrel (4), and the labor-saving vegetable cutter as claimed in claim 3, wherein an outer circumference of the inner barrel (4) fits with an inner circumference of the outer barrel (3) so that the inner barrel (4) is inserted into the outer barrel (3); wherein the cutting knife assembly (1) is arranged at a lower end of the inner barrel (4) and passes through a bottom of the inner barrel (4); wherein the pressing block (2) is arranged at a bottom of the outer barrel (3).

11. A labor-saving vegetable chopper, comprising: an outer barrel (3), an inner barrel (4), and the labor-saving vegetable cutter as claimed in claim 4, wherein an outer circumference of the inner barrel (4) fits with an inner circumference of the outer barrel (3) so that the inner barrel (4) is inserted into the outer barrel (3); wherein the cutting knife assembly (1) is arranged at a lower end of the inner barrel (4) and passes through a bottom of the inner barrel (4); wherein the pressing block (2) is arranged at a bottom of the outer barrel (3).

12. A labor-saving vegetable chopper, comprising: an outer barrel (3), an inner barrel (4), and the labor-saving vegetable cutter as claimed in claim 5, wherein an outer circumference of the inner barrel (4) fits with an inner circumference of the outer barrel (3) so that the inner barrel (4) is inserted into the outer barrel (3); wherein the cutting knife assembly (1) is arranged at a lower end of the inner barrel (4) and passes through a bottom of the inner barrel (4); wherein the pressing block (2) is arranged at a bottom of the outer barrel (3).

13. A labor-saving vegetable chopper, comprising: an outer barrel (3), an inner barrel (4), and the labor-saving vegetable cutter as claimed in claim 6, wherein an outer circumference of the inner barrel (4) fits with an inner circumference of the outer barrel (3) so that the inner barrel (4) is inserted into the outer barrel (3); wherein the cutting knife assembly (1) is arranged at a lower end of the inner barrel (4) and passes through a bottom of the inner barrel (4); wherein the pressing block (2) is arranged at a bottom of the outer barrel (3).

14. A labor-saving vegetable chopper, comprising: an outer barrel (3), an inner barrel (4), and the labor-saving vegetable cutter as claimed in claim 7, wherein an outer circumference of the inner barrel (4) fits with an inner circumference of the outer barrel (3) so that the inner barrel (4) is inserted into the outer barrel (3); wherein the cutting knife assembly (1) is arranged at a lower end of the inner barrel (4) and passes through a bottom of the inner barrel (4); wherein the pressing block (2) is arranged at a bottom of the outer barrel (3).
